(19) United States
(12) Patent Application Publication
(10) Pub. No.: US 2019/0225720 A1
(43) Pub. Date: Jul. 25, 2019

(54) PLATE COMPRISING 1-BUTENE POLYMER FOR 3D PRINTER

(71) Applicant: BASELL POLIOLEFINE ITALIA S.R.L., MILANO (IT)

(72) Inventors: ROBERTO DE PALO, FERRARA (IT); CLAUDIO CAVALIERI, FERRARA (IT)

(73) Assignee: BASELL POLIOLEFINE ITALIA S.R.L., MILANO (IT)

(21) Appl. No.: 16/339,091

(22) PCT Filed: Sep. 22, 2017
(86) PCT No.: PCT/EP2017/074121

§ 371 Date: Apr. 3, 2019

(30) Foreign Application Priority Data
Oct. 6, 2016 (EP) 16192534.2

(51) Int. Cl. C08F 110/08; C08J 5/18; B29C 64/245; B33Y 30/00

(52) U.S. Cl. CPC C08F 110/08; C08J 5/18; B29C 64/118; B33Y 30/00; C08J 2323/20; B29C 64/245

(57) ABSTRACT

A plate for use in an extrusion-based additive manufacturing system made from or containing a top layer made from or containing a sheet or film made from or containing 1-butene based copolymer made from or containing from 0 to 70 wt % of ethylene, propylene or alpha olefins of formula CH₂═CHR, wherein R is a C₃-C₂₀ alkyl radical, based upon the weight of the 1-butene polymer.

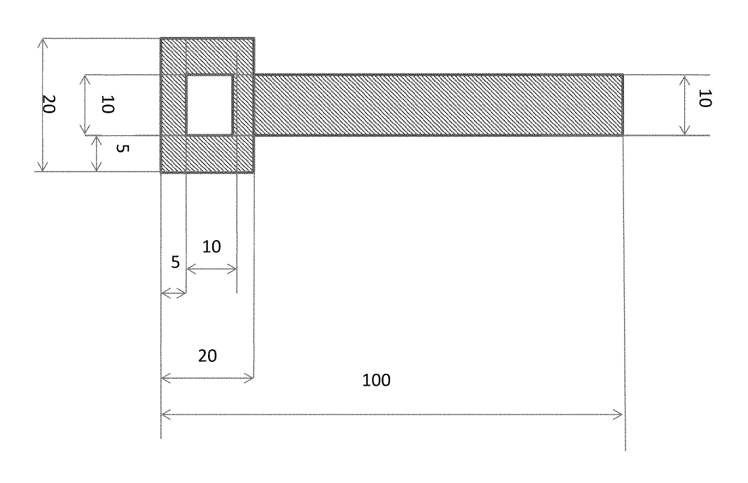

### FIELD OF THE INVENTION

In general, the present disclosure relates to the field of chemistry. More specifically, the present disclosure relates to polymer chemistry. In particular, the present disclosure relates to a base plate material made from or containing 1-butene based polymer.

### BACKGROUND OF THE INVENTION

An extrusion-based 3D printer is used to build a 3D model from a digital representation of the 3D model in a layer-by-layer manner by extruding a flowable modeling material. For example, a filament of the modeling material is extruded through an extrusion tip carried by an extrusion head and deposited as a sequence of roads on a substrate in an x-y plane. In some instances, the melted material is derived from a direct deposition from a screw extruder or similar or sintered from powders (SLS) The extruded modeling material fuses to previously-deposited modeling material and solidifies upon a drop in temperature. In some instances, the position of the extrusion head relative to the substrate is then incremented along a z-axis (perpendicular to the x-y plane), and the process is repeated to form a 3D model resembling the digital representation. Movement of the extrusion head with respect to the substrate is performed under computer control, in accordance with build data that represents the 3D model. The build data is obtained by slicing the digital representation of the 3D model into multiple horizontally sliced layers. For each sliced layer, the host computer generates a build path for depositing roads of modeling material to form the 3D model.

In the printing process, the plate holds the printing object such that the object does not move during the printing while allowing easy removal of the object when the printing is terminated.

### SUMMARY OF THE INVENTION

A plate made from or containing a top layer made from or containing a sheet or film made from or containing 1-butene based polymer made from or containing from 0 to 70 wt % of ethylene, propylene or alpha olefins of formula CH₂═CHR, wherein R is a C₃-C₂₀ alkyl radical, based upon the weight of the 1-butene based polymer, alternatively C₃-C₁₀ alkyl radical, is useful as a plate for extrusion-based 3D printing.

### BRIEF DESCRIPTION OF THE DRAWINGS

The FIGURE is a front view of an embodiment of a plate, which was used for the Examples. The measurements are in mm. When the 3D-printed object was complete, the object was 5 mm thick.

### DETAILED DESCRIPTION OF THE INVENTION

In a general embodiment, a plate for use in an extrusion-based additive manufacturing system made from or containing a top layer made from or containing a sheet or film, made from or containing 1-butene based polymer made from or containing from 0 to 70 wt % of ethylene, propylene or alpha olefins of formula CH₂═CHR, wherein R is a C₃-C₁₀ alkyl radical, based upon the weight of the 1-butene based polymer, alternatively C₃-C₈ alkyl radical is used as a plate for extrusion-based 3D printing.

As used herein, the term “sheet” refers to a sheet having thickness higher than 0.5 mm. As used herein, the term “film” refers to a sheet having thickness lower than 0.5 mm.

In some embodiments, the other layers of the plate are made of various materials. In some embodiments, the various materials are selected from the group consisting of polystyrene, polypropylene, and metals. In some embodiments, the metal is aluminum. In some embodiments, the plate is a heating plate. In some embodiments, the layer is a monolayer film or a multilayer film. In some embodiments, the top layer of the plate is made from or contains at least 30 wt %, alternatively at least 50 wt %, alternatively at least 70 wt %, alternatively at least 85 wt %; alternatively more than 99 wt % of 1-butene based polymer containing from 0 to 50 wt % of ethylene, propylene or alpha olefins of formula CH₂═CHR, wherein R is a C₃-C₁₀ alkyl radical, alternatively C₃-C₈ alkyl radical. In some embodiments, the plate is a sheet or a film of 1-butene based polymer. In some embodiments, the top layer is the only layer of the plate.

In some embodiments, the 1-butene based polymer contains from 0 to 50 wt %, based upon the weight of the 1-butene based polymer, of ethylene, propylene, 1-hexene or 1-octene as comonomers, alternatively, the comonomers are ethylene and propylene. In some embodiments, the amount of comonomer ranges from 2 to 20 wt %, based upon the weight of the 1-butene based polymer; alternatively from 4 to 10 wt %. In some embodiments, the 1-butene based copolymer is 1-butene homopolymer.

The amount of comonomer is determined by using ¹³C-NMR.

In some embodiments, the 1-butene based copolymer is isotactic, which means that the mmmm pentads measured with C¹³NMR is higher than 50 mol %; alternatively higher than 80 mol %.

In some embodiments, the 1-butene based polymers are available commercially under the tradenames PB-0110M and PB-03000M, from LyondellBasell.

In some embodiments, the melt flow rate (MFR ISO 1133 (190° C., 2.16 Kg) of the 1-butene based polymer ranges from 0.5 to 500.0 g/10 min; alternatively from 2.0 to 50.0 g/10 min.

In some embodiments, the 1-butene based polymer is used as a film on the plate as a top layer. In some embodiments, the film is a monolayer. In some embodiments, the film is a multilayer. In some embodiments, the film has an adhesive on one or both sides. In some embodiments, the film is easily replaced.

In some embodiments, the plate is heatable during the printing process.

In some embodiments, the plate is used with different filaments. In some embodiments, the filaments are selected from the group consisting of propylene-based filaments, nylon based filaments, ABS-based filaments, and PLA based filaments.

The following examples are given to illustrate and not to limit the present invention.

### EXAMPLES

The data of the propylene polymer materials were obtained according to the following methods:

Melt Flow Rate (MFR)

The melt flow rate MFR of the polymer was determined according to ISO 1133 (230° C., 2.16 Kg or 190° C.; 2.16 kg)

The following commercial polymers have been used for the plates

PB0300M polybutene homopolymer having a MFR of 4 g/10 min (190° C., 2.16 Kg) and a mmmm pentads higher than 50 mol %.

Adflex Q100F is a heterophasic propylene ethylene copolymer having an MFR of 0.6 g/10 min (230° C., 2.16 Kg) sold by LyondellBasell.

Plates were obtained by injection molding to produce a sheet having a thickness of about 2 mm.

Filaments

Polymers PP4 and PP5 were extruded to form a filament having 1.75 mm of diameter.

PP4 is commercial grade ADSYL 5C30F sold by LyondellBasell.
PP5 is commercial grade RP 210M sold by LyondellBasell.
Commercial PLA filament was also used.

Print Test

The printer was a 3D Rostock delta printer. The printer conditions were the followings:

| | | |
|---|---|---|
| Filament diameter | mm | 1.75 ± 0.03 |
| Nozzle diameter | mm | 0.4 |
| Temperature first layer | ° C. | 245 |
| Temperature other layers | ° C. | 245 |
| | | 1 |
| Layer high | mm | 0.2 |
| Infill | | 100% |
| printer speed | mm/min | 3600 |
| Speed first layer | | 60% |
| Speed other layers | | 100% |
| Speed infill | mm/min | 4.000 |

The sample was depicted in the FIGURE. For each filament, two printer tests were carried out at 40° C. and room temperature. At the end of the printing, the adhesion of the plate was verified. The results are reported on Table 1.

TABLE 1

| Plate | PP4 40° C. | PP4 RT | PP5 40° C. | PP5 RT | PLA RT |
|---|---|---|---|---|---|
| Q100F* | A2 | C3 | C1 | C3 | C0 |
| PB0300M | A3 | A3 | A3 | A3 | A3 |

*comparative
RT room temperature
A = the joint was adhesive and removable
C = the joint was cohesive
0 = no adhesion or cohesion
3 = complete adhesion or cohesion

Thus A value of A3 means that the adhesion was complete and the object was printable and removable.

What is claimed is:

1-10. (canceled)

11. A plate in an extrusion-based additive manufacturing system comprising:
a top layer comprising
a sheet or a film comprising
1-butene based polymer comprising
from 0 to 70 wt % of ethylene, propylene or alpha olefins of formula CH2=CHR, wherein R is a C3-C10 alkyl radical, based upon the weight of the 1-butene based polymer.

12. The plate according to claim 11, wherein the 1-butene based polymer contains from 0 to 70 wt % of ethylene, propylene, 1-hexene or 1-octene as comonomers, based upon the weight of the 1-butene based polymer.

13. The plate according to claim 11, wherein in the 1-butene based polymer is a copolymer and the amount of comonomer ranges from 2 to 20 wt %, based upon the weight of the 1-butene based polymer.

14. The plate according to claim 11, wherein the 1-butene based polymer is a 1-butene homopolymer.

15. The plate according to claim 11, wherein the 1-butene based polymer is isotactic having the mmmm pentads measured with C13NMR higher than 50 mol %.

16. The plate according to claim 11 wherein the melt flow rate (MFR ISO 1133 (190° C., 2.16 Kg) of the 1-butene based polymer ranges from 0.5 to 500.0 g/10 min.

17. The plate according to claim 11, wherein the melt flow rate (MFR ISO 1133 (190° C., 2.16 Kg) of the 1-butene based polymer ranges from 2.0 to 100.0 g/10 min.

18. The plate according to claim 11, wherein the sheet or film comprises at least 50 wt % of the 1-butene based polymer, based upon the weight of the sheet or film.

19. The plate according to claim 11, wherein the sheet or film comprises at least 70 wt % of the 1-butene based polymer, based upon the weight of the sheet or film.

20. The plate according to claim 11 wherein the sheet or film is the 1-butene based polymer.
